(19) United States
(12) Patent Application Publication
(10) Pub. No.: US 2009/0201254 A1
(43) Pub. Date: Aug. 13, 2009

(54) TRANSPORTABLE/CONVERTIBLE DESKTOP COMPUTER

(76) Inventor: Elliot Rais, New York, NY (US)

Correspondence Address: ISRAEL NISSENBAUM, 1038-56TH ST, BROOKLYN, NY, 11219, US

(21) Appl. No.: 12/135,186

(22) Filed: Jun. 8, 2008

Related U.S. Application Data
(60) Provisional application No. 61/064,015, filed on Feb. 8, 2008.
(60) Provisional application No. 61/064,320, filed on Feb. 27, 2008.
(60) Provisional application No. 61/069,204, filed on Mar. 13, 2008.
(60) Provisional application No. 61/124,259, filed on Apr. 15, 2008.

(51) Int. Cl. G06F 3/02

(52) U.S. Cl. 345/168

(57) ABSTRACT

A transportable desktop computer convertible to a notebook computer with minimal footprint. The computer has a screen element, with contained computer operational elements, and a support stand. The screen element is releasably hingedly attached to a keyboard element having two members with one member including the operational keyboard and pointing device the other being foldable under the keyboard for minimal keyboard footprint.

### FIELD OF THE INVENTION

This invention relates to convertible computers which can function as both notebook and desktop computers.

### BACKGROUND OF THE INVENTION

The notebook or laptop computer has become ubiquitous, with notebook computers being used both in and out of homes, places of business, in schools and during transit. There are few, if any, students who can function without a laptop computer, particularly in higher education courses and institutions. Travelling business people similarly find it indispensable for working on the road or even in the office.

The notebook computer can be transported and used with or without electrical connection (provided that the battery is charged) and it provides a portable access into the information world of the internet. The larger desktop computer has however, not disappeared or been supplanted since it is primarily larger and more comfortable and is preferably used when transport consideration needs are not as important and when utilization requirements are more demanding.

A laptop computer configuration typically embodies a hingedly attached screen and keyboard in a cramped and confined configuration. A desktop configuration is however generally restricted in use at a single site because of bulk and is normally not readily transportable.

There are few, if any, computers which truly embody the transportability and compactness of a laptop or notebook computer with the ease of use and comfort of a desktop computer. Though there have been numerous embodiments of laptop computers which have detachable keyboards and screens (a prime difference between notebook and desktop computers) this expedient, most often is not to provide a desktop configuration but rather to provide a tablet configuration for the separated screen.

### SUMMARY OF THE INVENTION

It is accordingly an object of the present invention to provide a computer with a configuration and conversion capability to provide a real desktop computer with a minimal footprint but which is closeable to a minimal size and transportable as a notebook computer and usable in both configurations.

It is a further object of the present invention to provide a notebook computer with a minimal desk top configuration and stabilized support for a screen having most of the computer components and weight therein.

Generally the present invention comprises a convertible desktop computer with the transportable capability of a notebook or laptop computer but with the configuration of a desktop computer with a minimized footprint. The present invention comprises a computer with a computer screen element with an integrated stowable support member to keep the screen essentially upright (alternatively, rather than being stowed, the support member may serve a dual purpose such as a support and carrying handle). The computer further comprises a keyboard element with areal dimensions similar to that of the computer screen element. The computer screen and keyboard elements are hingedly or separably attached to provide a transportable notebook configuration, when in the closed position.

In the open position, the support element of the computer screen element is deployed and the keyboard element may be detached from the screen element with the computer screen element being held in the substantially upright position. Electronic communication is effected by means of a circuit connection through a hinge element between the keyboard and screen when they are connected and via a retractable cable connection or transmitted signal (e.g., RF, blue tooth, IR and the like) when they are separated.

In accordance with the present invention, the keyboard element comprises two members preferably, though not necessarily, of similar areal dimension. A first member comprises the operational keyboard elements including keys and pointing device controls such as touch pad(s) and/or mouse or trackball. The second member of the keyboard element is primarily used to complete coverage of the screen element in the transportable configuration and is connected via a hinge to the first member or otherwise movably attached such as with sliding connection. Unlike typical keyboards the second member may have no operational elements, such as touch pads, as in many notebook computers. The second member primarily serves in conjunction with the keyboard member to physically match with the size of the screen element for closing into the transportable configuration. To reduce the excessive footprint, the excess keyboard portion is hinged and may be folded under the keyboard during use. Alternatively, the excess portion is slidably connected and capable of sliding under the operable keyboard. In a preferred embodiment, both the keyboard and the excess portion are cooperatively tapered such that the folded configuration provides an elevated keyboard which is tilted for facilitated use in comfort for touch typing. The area dimensions of the two members may be approximately the same for facilitated folding or placement and more congruent appearance, though this is not required.

In a second embodiment the keyboard element is not detachable from the screen element but the excess portion extends under the keyboard and screen and beyond in place of the support element with an overall desk top footprint similar to that of the first embodiment but without separation of the screen and keyboard. The support extension in this embodiment provides a stable base for the screen which is heavier and at a tilt, with otherwise susceptibility to tipping over.

The total footprint of the computer is minimally that of the folded keyboard and an upright screen with a small but sturdy support element or extension. For parking mode in embodiments with a separate support stand (non-immediate use but with immediate availability such as on a desk), the keyboard element can be folded into engagement with the screen element, with the space footprint being that of only the support element and the bottom edge of the folded screen and keyboard elements.

The above object and other objects, features and advantages of the present invention will become more evident from the following discussion and drawings in which:

### SHORT DESCRIPTION OF THE DRAWINGS

FIG. 1 is a front perspective view of the computer of the present invention in the upright folded position;

FIG. 2 is a rear perspective view of the computer of FIG. 1, shown in the screen-supported position;

FIG. 3 is a perspective view of the computer of FIG. 2, showing the hinge in the keyboard element;

FIG. 4 is a perspective side view of the computer of FIG. 3 showing the screen and keyboard being partially but not fully separated;

FIG. 5 is a front perspective view of the computer of FIG. 4 as fully opened in a standard notebook configuration;

FIG. 6 is a side perspective view of the computer of FIG. 4 with the members of the keyboard element being folded;

FIG. 7 is a side perspective view of the notebook computer configuration of FIG. 5 with folded keyboard elements;

FIG. 8 is a side perspective view of the computer of FIG. 7 with separation of the keyboard and screen elements into a desktop configuration;

FIG. 9 is a side perspective view of a second embodiment of the computer of the present invention, with a carrying handle extending from the second keyboard member which has been structurally strengthened;

FIG. 10 is a side view of a second embodiment of the computer of the present invention with the computer components and weight in the screen element;

FIG. 11 is a view of the computer of FIG. 10 with the keyboard element being unfolded;

FIG. 12 shows the computer of FIG. 11 with the folded keyboard section serving as computer support for the top weighted computer;

FIG. 13 is a perspective view of the computer of FIG. 12; and

FIG. 14 is a perspective view of another embodiment of the computer of the present invention with a slidable connection between the keyboard element memebers.

### DETAILED DESCRIPTION OF THE INVENTION AND DRAWINGS

With the configuration of the present invention, it is preferred that the computer CPU and power supply (e.g. battery and/or AC converter) and peripherals such as a DVD recorder/reader, USB ports, etc., are integrated with the screen. This is the reverse of notebook computers generally in which the power supply, CPU, drives and connection ports are contained in the keyboard section of the notebook computer. Keyboard activation and wireless communication power requirements are relatively minimal and the keyboard member may contain its own small rechargeable battery which is recharged when the keyboard element is attached to the screen element.

Since the folding keyboard contains no electronics it can be utilized as a storage receptacle for items such as USB backup drive, DVD discs, cable wire and the like.

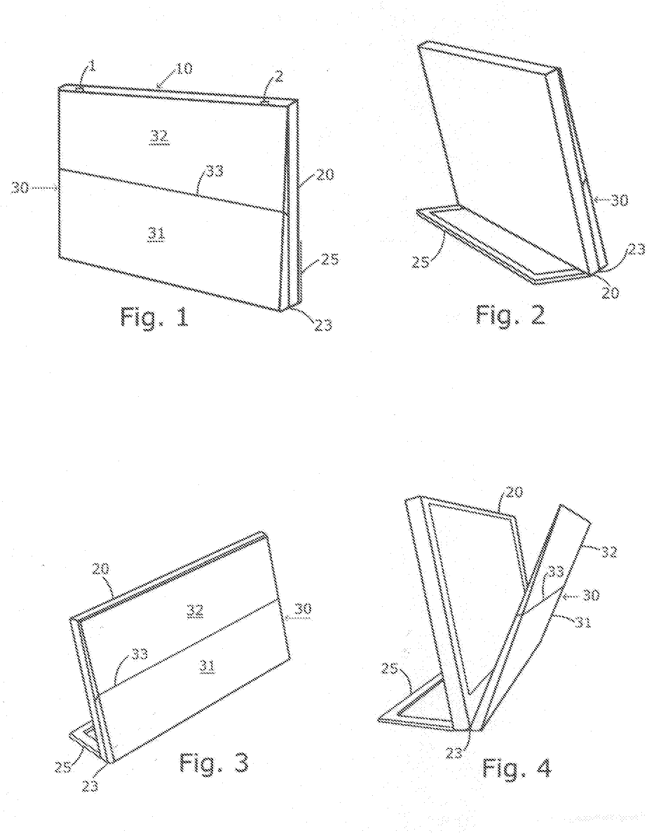

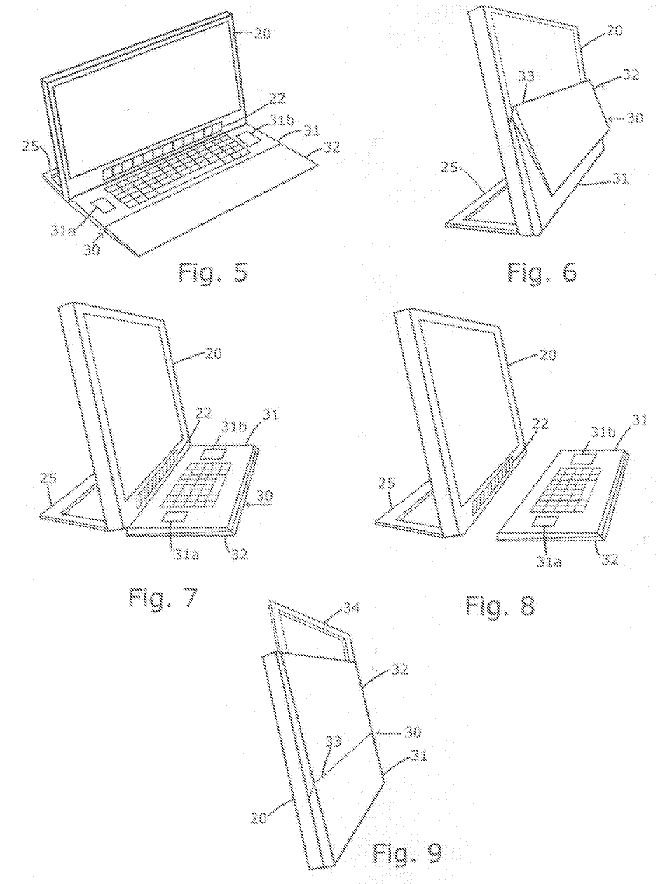

With specific reference to the drawings, in FIG. 1, the computer 10 is shown in a notebook or laptop transportable configuration with screen element 20 and integral support element 25 and keyboard element 30 with keyboard member 31 and folding keyboard member 32 in a stowed stacked position. Catches 1 and 2 lock the screen element 20 and keyboard element 30 and are releasable to open the computer. FIGS. 2 and 3 show support element 25 in the support position, with the computer 10 shown in a parked position suitable for minimal footprint placement on a desk. FIG. 4 shows the pivotable separation of screen element 20 and keyboard element 30 around hinge 23 to form the open position of the computer 10 shown in FIG. 5. Electrical connection between screen element 20 and keyboard element 30 is through the hinge element 23, when connected, as shown in FIGS. 5-7 and in the second embodiment shown in FIG. 13. As shown in FIG. 8, hinge 23 is detached and screen element 20 and keyboard element 30 are separated to form a desk top configuration. As with standard desk tops with separated keyboards, communication between keyboard member 31 and the screen element 20 with contained components is via any one of typical wireless connections such as RF, bluetooth, infra red and the like, or with a cable connection.

Folding keyboard member 32 is pivotable around hinge 33 as shown in FIG. 6 and foldingly fitted underneath keyboard member 31 to provide a small keyboard footprint as shown in FIGS. 7 and 8 from the large footprint shown in FIG. 5, typical of notebook computers. The smaller reach keyboard provides greater comfort in use as well as taking up less area of valuable desk space.

To permit the viable reduction in size of the keyboard, touch pads 31a and 31b may provided at either side of the keys of keyboard member 31 in place of the standard single touch pad commonly positioned in a notebook keyboard in a keyboard extension. Since function keys are relatively rarely utilized and are not part of a touch-typing operation they are provided on the screen element at 22 either below the screen as shown or alongside one or both sides of the screen (presumably the screen remains within arms length reach of the keyboard during use as is common with desktop computers).

The footprint of the keyboard is thereby reduced without sacrifice of utilization comfort. Keyboard member 31 and folding keyboard member 32 are preferably cooperatively tapered to provide either a tilted or level keyboard when folded together to further enhance utilization comfort. Alternatively, as shown in FIG. 14, hinge 33 is replaced with a sliding connection 40 between keyboard elements 31″ and 32″ with the latter being slidable under the keyboard 31″ during use and locked into extended position when the computer is not in use.

Movable screen element support stands 25 and 25″ in the first and third embodiments shown in FIGS. 1-8 and 14 are preferably held and moved with a relatively strong locking ratchet or other similar mechanism such that when an appropriate screen angle is attained for viewing, the screen can be locked into angled position to resist movement engendered by the heavy screen element (with contained power supply, CPU, disk drive, etc.). For aesthetics and to prevent snagging, it is preferred that the rear of screen element 20 be provided with a depressed area (not shown) to fittingly hold the support stand 25 in the closed position with a level surface. Similarly for aesthetic reasons and to prevent interference with computer utilization, as shown in FIG. 9, the folding keyboard member 32 is configured to contain a pull out handle 34 recessed within folding keyboard member 32. Alternatively, support stand 25 in FIG. 2 is provided with a ratchet lock (not shown) for co-extension relative to screen element 20 to provide the requisite transporting handle. Similarly, a pull out handle may be integrated with keyboard member 31 (not shown).

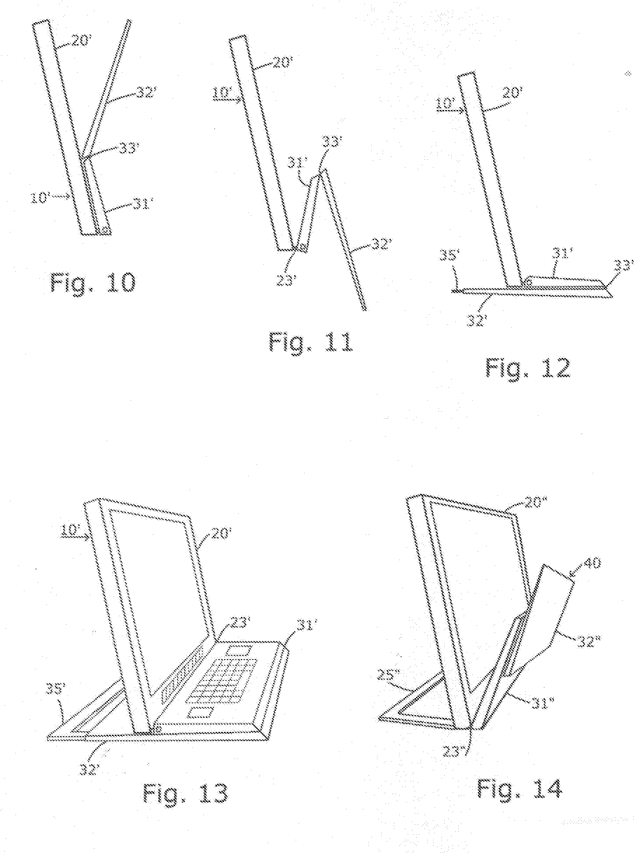

In the second embodiment shown in FIGS. 10-13, computer 10′ has a screen 20′ which contains the major portion of the computer components (CPU, battery, disk drive, etc.) and is heavy and normally liable to tipping when in the tilted viewing position shown in FIG. 13. To obviate this and while maintaining a small overall desk top footprint, keyboard element 30′ comprises keyboard member 31′ hingedly connected to screen element 20′ with hinge 23′ and to elongated member 32′ with hinge 33′. As shown in FIGS. 12 and 13 elongated member 32′ embodies extension 35 beyond the base of screen 20′ which serves to stabilize the computer in the operating position. Total footprint of the computer in FIGS. 12 and 13 is limited and essentially equivalent to that of the computer shown in FIGS. 7 and 8 of the first embodiment.

It is understood that the above description and embodiment is merely exemplary of the present invention and that details contained therein are not to be construed as limitations on the present invention. Changes in function and structure are possible without departing from the scope of the present invention as defined in the following claims.

What is claimed is:

1. A transportable desktop computer convertible to a notebook computer, comprising a screen element and a keyboard element, with the screen element comprising an integrated support stand capable of supporting the screen element in an operating position, the keyboard element comprising two members connected to each other, a first member comprising operative key members and a pointing device for the computer, and a second member configured to be placed under the first member during use of the key members, the screen element and the keyboard element being connected with a hinge member for use of the computer and transportation thereof as a notebook computer and with the hinge member being releasable wherein the screen element and keyboard element can be separated for configuration of the computer as a desk top computer, the screen element and keyboard element comprising communication elements for operation communication between the separated keyboard element and the screen element.

2. The transportable desktop computer of claim 1, wherein the communication elements comprise a wired connection between the screen element and keyboard element.

3. The transportable desktop computer of claim 1, wherein the communication elements comprise wireless communication elements in the screen element and keyboard element.

4. The transportable desktop computer of claim 1, wherein the integrated support stand is configured to function as a carrying handle.

5. The transportable desktop computer of claim 1, wherein at least one of the first and second member is configured to contain a retractable carrying handle.

6. The transportable desktop computer of claim 1, wherein the first and second members of the keyboard element are cooperatively tapered with the second member being placed under the first member to provide a desired operating angle for the keyboard.

7. The transportable desktop computer of claim 1, wherein the first member is configured to be removably hingedly attached to the screen element and with the first member having a pointing device control thereon.

8. The transportable desktop computer of claim 1, wherein function keys of the computer are positioned on the screen element.

9. The transportable desktop computer of claim 8, wherein the screen element contains a power supply, a CPU and a disk drive for the computer and the keyboard element contains an auxiliary power supply sufficient to power communication and operation of the keyboard.

10. The transportable desktop computer of claim 1, wherein the second member is configured to function as a storage element.

11. The transportable desktop computer of claim 1, wherein the first and second members of the keyboard element are connected with a hinge and wherein the second member is hingedly folded under the first member during use as a computer.

12. The transportable desktop computer of claim 1, wherein the first and second members of the keyboard element are connected with a sliding connection and wherein the second member slides under the first member during use as a computer

13. A transportable computer having a reduced desktop configuration, comprising a screen element and a keyboard element, with the screen element comprising a significant portion of the components and weight of the computer, the keyboard element comprising two members connected to each other, a first member comprising operative key members and a pointing device for the computer, and a second member configured to be placed under the first member during use of the key members, the screen element and the keyboard element being connected with a hinge member for use of the computer and transportation thereof as a notebook computer, the second member being dimensioned such that a portion of the second member extends beyond a base of the screen element with the screen element being stabilized in operating position.
